(19) United States
(12) Patent Application Publication
(10) Pub. No.: US 2004/0248519 A1
(43) Pub. Date: Dec. 9, 2004

(54) Data transmission method, system and network element

(76) Inventor: Kari Niemela, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/620,764

(22) Filed: Jul. 17, 2003

Related U.S. Application Data
(60) Provisional application No. 60/471,326, filed on May 19, 2003.

(51) Int. Cl. H04Q 7/34; H04Q 7/20

(52) U.S. Cl. 455/67.11; 455/423

(57) ABSTRACT

A data transmission system compensates Doppler shift in a telecommunication system in which system at least one user terminal is moving in relation to a network element. The system includes means for measuring a received uplink signal, and means for estimating the amount of Doppler frequency compensation for at least one downlink signal related to the user terminal on the basis of the measured received uplink signal. Means are provided for compensating the Doppler shift for at least one downlink signal related to the user terminal by shifting the frequency of the signal according to the estimated amount of Doppler frequency compensation.

### CROSS REFERENCE TO RELATED APPLICATIONS

This application claims priority of U.S. Provisional Patent Application Serial No. 60/471,326 entitled “Data Transmission Method, System and Network Element,” filed on May 19, 2003, the contents of which are hereby incorporated by reference.

### BACKGROUND OF THE INVENTION

1. Field of the Invention

The invention relates to a data transmission method, system and a network element.

2. Description of the Related Art

Nowadays fast traffic connections like bullet trains become more and more popular due to increasing connections. This creates a growing demand for reliable telecommunication connections also when a user terminal is moving fast.

One problem with high-speed trains is that when a receiver is immobile, as base stations usually are, and a transmitter is moving fast in relation to the receiver, a phenomenon called Doppler effect takes place.

The Doppler effect was first defined by C. Doppler in 1842. The Doppler effect is an example of time warping or delay modulation. The Doppler shift changes signal's carrier frequency, scales the time axis of the complex envelope and changes the amplitude of the signal.

If the frequency is changing excessively, it is possible that a call is dropped.

There are also timing and signalling problems in the handover process on a fast moving train.

### SUMMARY OF THE INVENTION

The invention relates to a method for compensating Doppler shift in a telecommunication system, where at least one user terminal is moving fast in relation to a network element. The method includes measuring a received uplink signal, estimating the amount of Doppler frequency compensation for at least one downlink signal related to the user terminal on the basis of the measured received uplink signal, and compensating the Doppler shift for at least one downlink signal related to the user terminal by shifting the frequency of the signal according to the estimated amount of Doppler frequency compensation.

The invention also relates to a method for compensating Doppler shift in a telecommunication system, where at least one user terminal is moving fast in relation to a network element and where there are at least two radio cells One of the radio cells is a handover source cell and another a handover target cell. The method includes measuring a received uplink signal in the source cell, estimating in the source cell the amount of Doppler frequency compensation for at least one downlink signal related to the user terminal on the basis of the measured received uplink signal. The Doppler shift in the source cell is compensated for at least one downlink signal related to the user terminal by shifting the frequency of the signal according to the estimated amount of Doppler frequency compensation. The handover target cell is informed of the required Doppler shift compensation while performing a handover, and the amount of Doppler frequency compensation is estimated for at least one user terminal related downlink signal of the handover target cell utilizing the information on the required Doppler shift compensation communicated from the source cell and angles of velocity.The Doppler shift is compensated in the handover target cell for at least one downlink signal related to the user terminal by shifting the frequency of the signal according to the amount of Doppler frequency compensation estimated in the handover target cell.

The invention also relates to a data transmission system for compensating Doppler shift in a telecommunication system in which system at least one user terminal is moving fast in relation to a network element. The system includes means for measuring a received uplink signal, means for estimating the amount of Doppler frequency compensation for at least one downlink signal related to the user terminal on the basis of the measured received uplink signal, means for compensating the Doppler shift for at least one downlink signal related to the user terminal by shifting the frequency of the signal according to the estimated amount of Doppler frequency compensation.

The invention also relates to a data transmission system for compensating Doppler shift in a telecommunication system in which system at least one user terminal is moving fast in relation to a network element and in which system there are at least two radio cells, one of them being a handover source cell and another a handover target cell. The system includes means for measuring a received uplink signal in a source cell, means for estimating in the source cell the amount of Doppler frequency compensation for at least one downlink signal related to the user terminal on the basis of the measured received uplink signal, means for compensating the Doppler shift in the source cell for at least one downlink signal related to the user terminal by shifting the frequency of the signal according to the estimated amount of Doppler frequency compensation, means for informing the handover target cell of the required Doppler shift compensation while performing a handover, means for estimating the amount of Doppler frequency compensation for at least one user terminal related downlink signal of the handover target cell utilizing the information on the required Doppler shift compensation communicated from the source cell and angles of velocity, means for compensating the Doppler shift in the handover target cell for at least one downlink signal related to the user terminal by shifting the frequency of the signal according to the amount of Doppler frequency compensation estimated in the handover target cell.

The invention also relates to a network element for compensating Doppler shift. This embodiment includes: means for receiving measurement results regarding uplink signals, means for estimating the amount of Doppler frequency compensation for at least one downlink signal on the basis of the measured uplink signal, means for compensating the Doppler shift for at least one downlink signal by shifting the frequency of the signal according to the estimated amount of Doppler frequency compensation.

The invention also relates to a network element for compensating Doppler shift in a telecommunication system in which system there are at least two radio cells, one of them being a handover source cell and another a handover target cell. The network element includes means for receiving measurement results regarding uplink signals in a source cell, means for estimating in the source cell the amount of Doppler frequency compensation for at least one downlink signal the basis of the measured uplink signal, means for compensating the Doppler shift in the source cell for at least one downlink signal by shifting the frequency of the signal according to the estimated amount of Doppler frequency compensation, means for informing the handover target cell of the required Doppler shift compensation while performing a handover, means for estimating the amount of Doppler frequency compensation for at least one downlink signal of the target cell utilizing the information on the required Doppler shift compensation communicated from the source cell and angles of velocity, means for compensating the Doppler shift in the target cell for at least one downlink signal by shifting the frequency of the signal according to the amount of Doppler frequency compensation estimated in the target cell.

Further embodiments of the invention are described in the dependent claims.

The method and system of the invention provide several advantages. The reception of a downlink signal is improved due to better Doppler correction. Another embodiment of the invention further improves a handover process when a user terminal is moving fast in relation to a base station.

### BRIEF DESCRIPTION OF THE DRAWINGS

In the following, the invention will be described in greater detail with reference to the preferred embodiments and the accompanying drawings, in which

FIG. 1 shows a simplified example of a telecommunication system;

FIG. 2 illustrates the Doppler effect;

FIG. 3 is a flow chart;

FIG. 4 illustrates a block diagram of a part of a transmitter; and

FIG. 5 shows an example of a handover situation.

### DESCRIPTION OF THE PREFERRED EMBODIMENTS

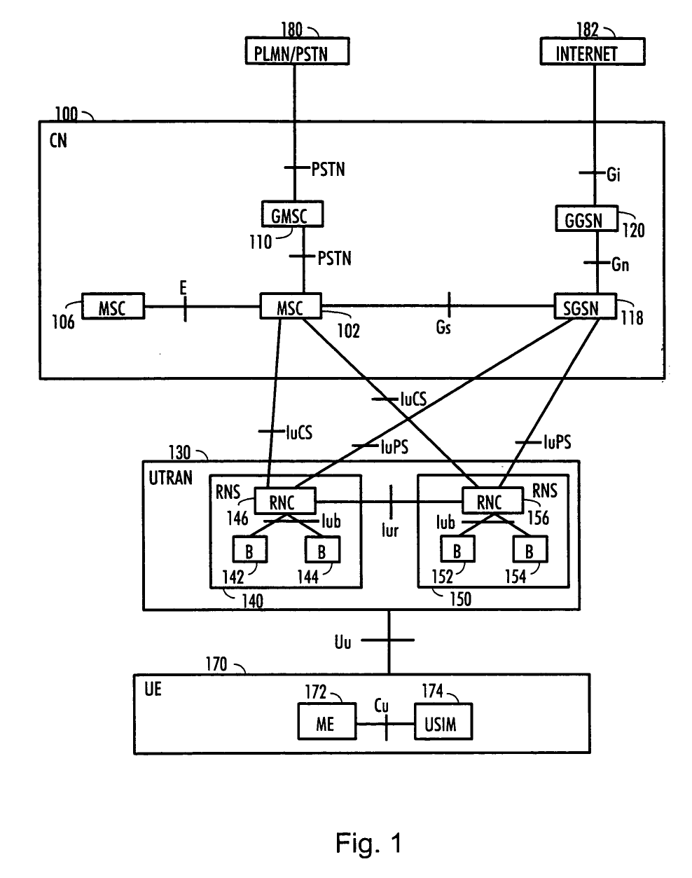

With reference to FIG. 1, we examine an example of a data transmission system is shown in which the preferred embodiments of the invention can be applied. In FIG. 1 the embodiments are described in a simplified radio system, which represents a Code Division Multiple Access, CDMA, system. The Code Division Multiple Access technique is used nowadays for example in radio systems which are known at least by the names IMT-2000 (International Mobile Telecommunications 2000) and UMTS (Universal Mobile Telecommunications System). The invention is not, however, restricted to these systems given as examples but a person skilled in the art may apply the solution in other radio systems provided with the necessary properties.

FIG. 1 is a simplified block diagram, which describes the most important network elements of the radio system and the interfaces between them. The structure and function of the network elements are not described in detail because they are commonly known.

The main parts of the radio system are a core network (CN) 100, a radio access network 130 and user equipment (UE) 170. The term UTRAN is an abbreviation of UMTS Terrestrial Radio Access Network, i.e. the radio access network belongs to the third generation and is implemented by wideband code division multiple access WCDMA. Generally, the radio system can also be defined as follows: the radio system includes a user terminal, which is also called a subscriber terminal or a mobile station, and of a network part, which includes the fixed infrastructure of the radio system, i.e. a core network, a radio access network and a base station system.

A mobile services switching center (MSC) 102 is the center of the circuit-switched side of the core network 100. The mobile services switching center 102 is used to serve the connections of the radio access network 130. The tasks of the mobile services switching center 102 typically include switching, paging, user terminal location registration, handover management, collection of subscriber billing information, data encryption parameter management, frequency allocation management and echo cancellation.

The number of mobile services switching centers 102 may vary: a small network operator may have only one mobile services switching center 102, whereas large core networks 100 may have several ones. FIG. 1 shows another mobile services switching center 106 but its connections to other network elements are not illustrated to keep FIG. 1 sufficiently clear.

Large core networks 100 may comprise a separate gateway mobile services switching center (GMSC) 110, which is responsible for circuit-switched connections between the core network 100 and the external networks 180. The gateway mobile services switching center 110 is located between the mobile services switching center 102, 106 and the external networks 180. The external network 180 may be, for example, a public land mobile network PLMN or a public switched telephone network PSTN.

The core network 100 typically comprises other parts, too, such as a home location register HLR, which includes a permanent subscriber register and, if the radio system supports the GPRS, a PDP address (PDP=Packet Data Protocol), and a visitor location register VLR, which includes information on roaming of the user terminals 170 in the area of the mobile services switching center 102. All the parts of the core network are not shown in FIG. 1 to keep it clear.

A serving GPRS support node (SGSN) 118 is the center of the packet-switched side of the core network 100. The main task of the serving GPRS support node 118 is to transmit and receive packets with the user terminal 170 supporting packet-switched transmission, utilizing the radio access network 130. The serving GPRS support node 118 includes user information and location information on the user terminal 170.

A gateway GPRS support node (GGSN) 120 on the packet-switched side corresponds to the gateway mobile services switching center 110 of the circuit-switched side, with the exception that the gateway GPRS support node 120 has to be able to route outgoing traffic from the core network 100 to external networks 182, whereas the gateway mobile services switching center 110 routes only the incoming traffic. In the example, the external networks 182 are represented by the Internet, via which a considerable part of wireless telephone traffic can be transmitted in the future.

The radio access network 130 includes radio network subsystems 140, 150. Each radio network subsystem 140, 150 consists of radio network controllers (RNC) 146, 156 and B nodes 142, 144, 152, 154. The B node is rather an abstract concept, which is frequently replaced by the term ‘base station’.

The radio network controller 146, 156 is usually responsible for the following tasks, for example: management of the radio resources of the base transceiver station or B-node 142, 144, 152, 154, intercell handover, measurement of time delays on the uplink, implementation of the operation and management interface, and management of power control.

The radio network controller 146, 156 includes at least one transceiver. One radio network controller 146, 156 may serve one cell or several sectorized cells. The cell diameter may vary from a few meters to dozens of kilometers. The radio network controller 146, 156 is often deemed to include a transcoder, too, for performing conversion between the speech coding format used in the radio system and the speech coding format used in the public switched telephone system. In practice, however, the transcoder, controller 146, 156 is usually responsible for the following tasks, for example: measurements on the uplink, channel coding, encryption and scrambling coding.

The user terminal 170 usually includes two parts: mobile equipment (ME) 172 and a UMTS subscriber identity module (USIM) 174. The user terminal 170 comprises at least one transceiver for establishing a radio connection to the radio access network 130. The user terminal 170 may include at least two different subscriber identity modules. In addition, the user terminal 170 comprises an antenna, a user interface and a battery. Nowadays various kinds of user terminals 170 are available, e.g. terminals that are installed in a car and portable terminals. The user terminals 170 also have properties similar to those of a personal computer or a portable computer.

The USIM 174 includes information on the user and information on data security, e.g. an encryption algorithm, in particular.

It is obvious to a person skilled in the art that the interfaces included in the radio telecommunications system are determined by the hardware implementation and the standard used, for which reason the interfaces of the system may differ from those shown in FIG. 1. In the UMTS, the most important interfaces are the lu interface between the core network and the radio access network, which is divided into the luCS (CS=Circuit Switched) interface of the circuit-switched side and the luPS (PS=Packet Switched) interface of the packet-switched side, and the Uu interface between the radio access network and the user terminal. The interface defines what kind of messages different network elements may use to communicate with one another. The object of the standardization of interfaces is to enable function between network elements of different producers. In practice, however, some of the interfaces are producer-specific.

In the following, the Doppler effect is explained in further detail. Whenever relative motion exists between a transmitter and a receiver, there is an apparent shift in the frequency of the received signal due to the Doppler effect. Additionally, when either the transmitter or the receiver is in motion, there is a so-called dynamic multi-path situation in which there is a continuous change in the electrical length of every propagation path and thus the relative phase shifts between them change as a function of a spatial location. The received amplitude (envelope) of the signal varies. At some positions there is constructive addition while at others there is almost complete cancellation. In practice, there are of course several different paths which combine in different ways depending on a location.

The time variations, or dynamic changes in the propagation path lengths, can be related directly to the motion of the receiver and indirectly to the Doppler effects that arise. The rate of change of phase, due to motion, is apparent as a Doppler frequency shift in each propagation path.

The phase change is therefore

$$Δ φ = - \frac{2 π}{λ} Δ l , \qquad ( 1 )$$

where

λ is a wave length,

ΔI is an incremental change in the path length of the wave dcos α.

The apparent change in frequency (the Doppler shift) is

$$f = - \frac{1}{2 π} \frac{Δ φ}{Δ t} = \frac{v}{λ} cos α = \frac{{vf}_{c}}{c} cos α , \qquad ( 2 )$$

where

Δφ is a phase change,

Δt is an incremental change of time,

v=velocity,

λ is a wave length,

α is an angle of velocity related to the base station,

f_{c} is a carrier frequency,

c is speed of light, 3*10⁸ m/s.

It is clear that the change in path length is depending on the spatial angle between the wave and the direction of motion. Generally, waves arriving from ahead of a user terminal have a positive Doppler shift i.e. an increase in frequency, while the reverse is the case for waves arriving form behind the user terminal. Waves arriving from directly ahead of, or directly behind the user terminal are subjected to the maximum rate of change of phase, giving

$${f}_{m} = \frac{v}{λ} , \qquad ( 3 )$$

where

v=d/Δt, where d is an incremental distance,

λ is a wave length.

In practice, the several incoming paths will be such that their individual phases, as experienced by a moving receiver, will change continuously and randomly. The resultant signal envelope and RF phase will therefore also be random variables.

If the multi-path signals have frequencies close together, the different propagation paths within the multi-path medium have approximately the same electrical length for all components and their amplitude and phase variations are very similar. This is called flat fading. There is also frequency-selective fading where the behaviour of one frequency tends to become uncorrelated with that at the other frequency, because the phase shifts along the various paths are different at the two frequencies.

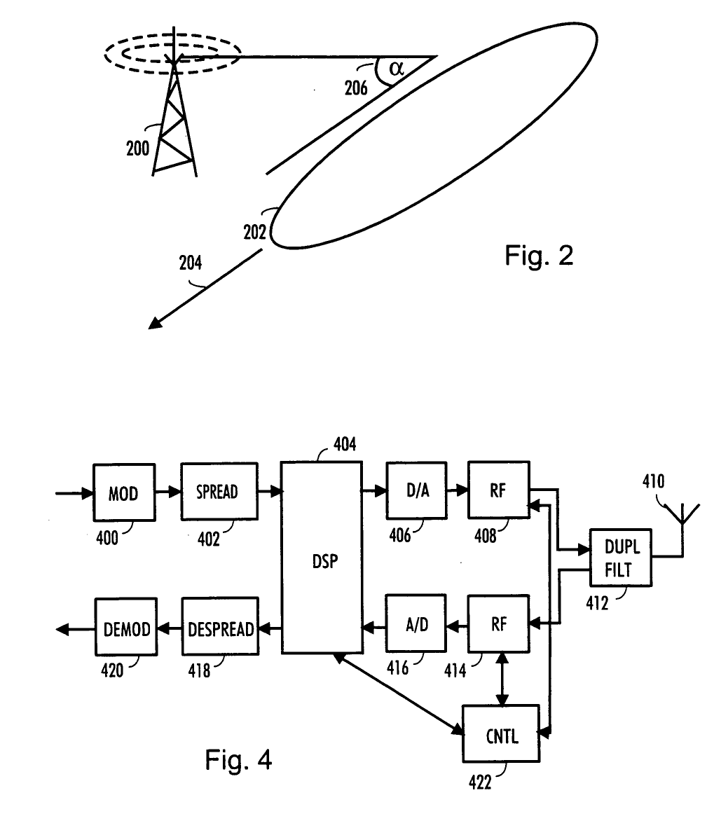

FIG. 2 illustrates the Doppler effect with the aid of an example. The base station 200 is immobile and it is generating one or more radio cells along the railway. A bullet train 202 is moving fast in the direction of the arrow 204. The angle of form (2) marked with a symbol α 206 describes the direction of a motion of the train in relation to the base station (an angle of velocity). The frequency the base station receives changes according to the speed, distance and/or direction of the train (and to the frequency itself as explained in forms (1), (2) and (3).

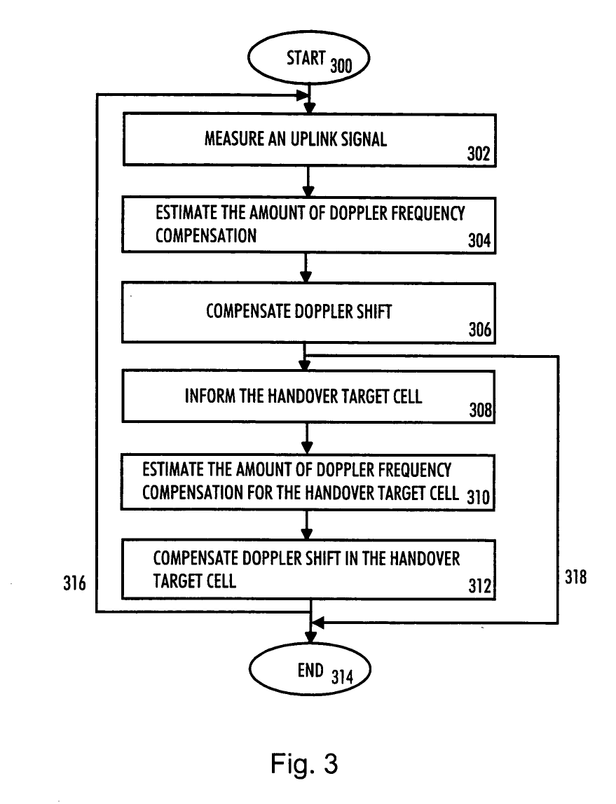

FIG. 3 is a flow chart describing an embodiment of the invention. In the systemwhich implements this method, there are preferably at least one base station and one or more subscriber terminals which are moving fast in relation to the base station.

Typically, the user terminal uses the signal received from a base station as a frequency reference signal. The fast moving user terminal is not able to separate the Doppler shift it experiences from the error of its own oscillator. Usually, the user terminal estimates the Doppler shift and minimizes it by tuning its oscillator. The user terminal tunes its own oscillator based on the estimated mean of the received Doppler shifted signals in order to compensate the mean Doppler frequency component. The user terminal uses the Doppler shifted frequency when generating the transmission signal. Thus the frequency of the signal the user terminal transmits is adapted according to the estimated Doppler shift. In this application, this is called frequency offset. In the receiver, the frequency offset is defined by comparing the known carrier frequency and the most frequent received frequency.

Therefore, the base station receiver experiences both the Doppler effect and the frequency offset made by the tuned oscillator of the moving subscriber terminal. The accuracy of the user terminal's transmission frequency is typically about 10-7 (0.1 ppm). Therefore, the maximum Doppler shift in the base station receiver is about twice the Doppler shift experienced by the user terminal.

The method described below teaches one example of how to compensate the Doppler shift experienced by the base station. As an example of a fast moving vehicle or a means of conveyance is given a high-speed train which is also called a bullet train.

The method starts from block 300. In block 302 the received uplink signal is measured to find out how much the frequency changes due to the Doppler effect. The target of the measuring is to find out the mean frequency offset of the received signal. The estimation of the mean frequency may utilize the predetermined or measured quality of the received signal as a weighting or filtering factor in order to improve the accuracy of estimation. The measurement period may include one or several transport blocks or bursts.

In block 304 the amount of Doppler frequency compensation for downlink is estimated on the basis of an uplink signal. The superposition can be applied for the Doppler effect, thus the downlink and the uplink are assumed to have characteristics that are similar enough when compared to each other. The estimation may take into account the previously preformed compensation and/or an uplink/downlink carrier frequency separation a.k.a. duplex frequency, albeit the impact of the duplex frequency is typically very little. The compensation and measurement periods are determined in such a way that a possible oscillation is avoided. The amount of the downlink frequency compensation (Doppler frequency compensation) may be estimated by using the formula

$${AFC}_{DL} ( n + 1 ) = \frac{{AFC}_{DL} ( n ) - {f}_{d\_UL \_mean} ( n ) \cdot \frac{{f}_{c\_DL}}{{f}_{c\_UL}}}{2} , \qquad ( 4 )$$

where

AFC_{DL}(n) is earlier made compensation,

f_{d}_{_{—}}_{UL}_{_{—}}ₘₑₐₙ(n) is a measured mean frequency error on uplink,

f_{c}_{_{—}}_{DL} is a carrier frequency for downlink and

f_{c UL} is a carrier frequency for uplink.

In block 306 the Doppler shift for at least one downlink signal related to the user terminal is compensated by shifting the frequency of the signal according to the estimated amount of Doppler frequency compensation. The compensation can be seen in the I/Q-domain as a rotation of the signal. In WCDMA systems the compensation is performed, for instance, for selected pilot signals and/or channels related to them, while in TDMA, for instance, for a selected logical channel or time slots. It is also possible to create, for terminals on train, the cells of their own. Then the compensation is performed for the selected cells. Thus the compensation can be targeted to the desired user terminals on the bullet train or under the similar circumstances.

The sign of the Doppler shift typically changes rapidly due to handovers which occur quite frequently due to a high speed. In another embodiment of the invention, handovers are utilized for informing the target cell of the Doppler frequency compensation made in a source cell. Thus the system may include at least two radio cells, one of them is a handover source cell and another is a handover target cell

In handover, the estimated amount of Doppler frequency compensation, the frequency offset, and/or the measured received uplink signal, is given to the target cell of the handover as information required for Doppler shift compensation. The information is communicated as a part of the handover control carried out by a base station controller or another network element having the same role. This is done in block 308.

In the receiver, the frequency offset is defined by comparing the known carrier frequency and the most frequent received frequency. Then the frequency offset is preferably averaged to get the frequency offset value which is the most appropriate for a pre-determined period of time which typically is at least the time the subscriber terminal stays n one cell.

Assuming that the oscillator tuning in the user terminal has a larger time constant than used during the measurement period in the source cell, the Doppler frequency compensation on the target cell (B) can be initialized by using the measured received uplink signal of the source cell (A). The mean Doppler frequency of the target cell of the handover (the cell B) can be estimated

$${f}_{d\_UL \_mean \_initial} ( B ) = {f}_{d\_UL \_mean} ( A ) \cdot \frac{cos β}{cos α} \cdot \frac{{f}_{c\_UL} ( B )}{{f}_{c\_UL} ( A )} , \qquad ( 5 )$$

where,

fd_UL_mean(A) is the mean Doppler frequency estimate on source cell,

α is the angle of velocity related to the source cell,

β is the angle of velocity related to the target cell,

f_{c}_{_{—}}_{UL}(A) is a carrier frequency for uplink used in a source cell,

f_{c}_{_{—}}_{UL}(B) is a carrier frequency for uplink used in a target cell.

This is done in block 310. In block 312 the Doppler shift for at least one downlink signal (in the target cell) related to the user terminal is compensated by shifting the frequency of the signal according to the estimated amount of Doppler frequency compensation. The compensation can be seen in the I/Q-domain as a rotation of the signal. In WCDMA systems the compensation is performed, for instance, for selected pilot signals and/or channels related to them, while in TDMA, for instance, for a selected logical channel or time slots. It is also possible to create for terminals on train the cells of their own. Then the compensation is performed for the selected cells. Thus the compensation can be targeted to the desired user terminals on the bullet train or under the similar circumstances.

The benefit attained by using the embodiment explained below, is that usually it is sufficient to transfer only one value to the target base station for initializing the Doppler compensation algorithm. The same value may be used to initialize the uplink compensation in addition to the downlink algorithm.

The information on a railway topology can be stored in the base station controller or another network element having the same role. Therefore, the base station can concentrate on the physical layer of the OSI-model (layer 1 L1) processing (OSI means open systems interconnection). Thus in the estimation of the Doppler shift, information on system geometry can be utilized: the angles cosα and cosβ (cosβ/cosα) give the sign of the required compensation and also the relative magnitude.

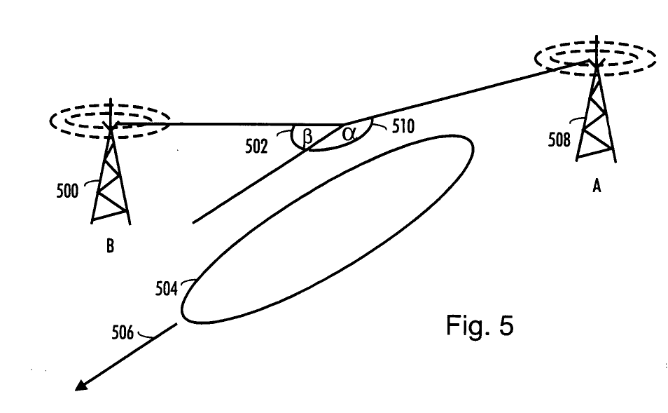

According to the example of FIG. 5, the base stations 500 and 508 are immobile and they are generating radio cells along the railway. A bullet train 504 is moving fast in the direction of the arrow 506. The base station B 500 is creating the handover target cell and the base station A 508 is creating the handover source cell. The angle of velocity of the train 504 related to the source cell is the angle a 510 and the angle of velocity of the train 504 related to the target cell is the angle β 502.

The determination of the angles requires train locating. Also the locations of base stations have to be known.

It should be noticed that the geometry information may not always be needed, for example if both the source (A) and the target (B) base stations are closely located to the railway and the railway is reasonably straight.

It is also possible to compensate the frequency offset of the common channels and/or other critical channels before the user terminal arrives to the cell and starts listening to them. This is possible when a so-called blind handover is used. The compensation may also be based on timing advances reported by the user terminal.

The method ends in block 314. Arrow 316 depicts one possibility for repeating the method. Arrow 318 depicts the difference between the embodiments of the invention described above.

Radio cells need to overlap in order to perform successful handovers. The overlapping area has to be large enough to ensure that the user terminal has enough time for performing handover measurements including cell identification and a possible comparison of the relative cell attractiveness, reporting and handover signalling with the base station subsystem. The signalling channel capacity and the signalling related to the number of active users on a bullet train may affect to the size of the overlapping area. The length of the train and the distribution of users on it may have little impact as well. For instance, if the minimum time for a subscriber terminal to move through an overlapping zone is 8.5 seconds, the range equals 830 m when the speed of the train is 350 km/h. The network planning determines the basic sizes and shapes of the cells according to above-mentioned constraints.

It is also possible to perform Doppler offset measurements in the user terminal for several cells and to transmit the measurement results to the base station sub-system for the down-link Doppler compensation, but in that case cell synchronization usually takes longer than in the former compensation.

There are environments such as tunnels that may require further attention also in the Doppler compensation. If the radio coverage in a tunnel is built with leaky feeders, the Doppler shift may be multiplied with the factor (effective dielectric constant) indicated for a leaky feeder. On the other hand the Doppler compensation algorithm may be adapted to the leaky feeder situation, if the effective dielectric constant is typically in the order of 1 . . . 1.5.

When trains are passing each other, it is possible to reserve individual resources for both of the trains or for both of the directions and perform a resource-based compensation. The resource may be a radio cell or a channel. Thus it is possible to use different Doppler compensation values having opposite signs for the both of the trains.

FIG. 4 shows an example of a base station transceiver, which is an example of a network element. The structure of base stations of handover source cells and handover target cells are similar to each other. The transceiver can use the same antenna 410 for receiving and transmitting, and therefore there can also be a duplex filter 412 to separate transmission and reception. The antenna may be an antenna array or a single antenna. In a receiver RF-parts 414 in this case comprise also a power amplifier which amplifies the received signal attenuated on a radio path. Typically RF-parts down-convert a signal to an intermediate frequency and then to a base band frequency or straight to base band frequency. The analogue-to-digital converter 416 converts an analogue signal to digital form by sampling and quantizing.

The depicted system can be a spread-spectrum system and thus a broadband signal is de-spread in block 418. One possibility to de-spread a signal is to multiply it with the same code it was spread in a transmitter. This is called a direct-sequence spread spectrum system. If the system is a narrow-band system the de-spreading block will not be required.

Then the signal is demodulated in block 420 which means that the information is separated from the carrier.

The Digital Signal Processing (DSP) block 404 is shared by a receiver and a transmitter. There could also be separate DSP-blocks for both. Typical functions of a DSP-block are, for example, scrambling, interleaving, coding, pre-distortion and pulse shaping for transmission and corresponding removal functions for reception such as descrambling decoding etc. Digital Signal Processing is known in the art.

In a transmitter, the signal is first modulated in block 400. Modulation means that a data stream modulates a carrier. The modulated signal characteristic may be, frequency or phase, for example. Modulation methods are known in the art and therefore they are not explained here in greater detail.

Because the system in FIG. 4 is a wide-band system the signal is spread for example by multiplying it with a long pseudo-random code. Spreading is done in block 402. If the system is a narrow-band system, the spreading block will not be required.

Block 406 converts the signal into an analogue form. RF-parts in block 408 up-convert the signal to a carrier frequency, in other words a radio frequency either via an intermediate frequency or straight to the carrier frequency. In this example, RF-parts also comprise a power amplifier which amplifiers the signal for a radio path.

Block 422 is a control block which typically is a part of the DSP-block, but it is depicted here as a separate block to emphasize its functions. Receiver measurements are typically made in the RF parts of a receiver 414. The aim of the measurements is to find out the frequency at which the most frequent amplitude value is received. The control block then estimates a frequency offset for the Doppler compensation. This is preferably done by comparing the known carrier frequency and the most frequent received frequency. The frequency difference is the frequency offset. Then the frequency offset is preferably averaged to obtain the frequency offset value which is the most appropriate for a pre-determined period of time which typically is at least the time the subscriber terminal stays in one cell. The control block also determines a Doppler compensation value and gives to the RF block 414 or the DSP 404 block the information on the required frequency compensation. The RF block 414 or the DSP block 404 then carries out the change of the reception frequency. This is typically done by adjusting channel-based the numerically controlled oscillator of the DSP block 404 or by adjusting the carrier frequency of the radio cell. The uplink and downlink compensations are performed separately and they are typically of opposite signs.

The disclosed functionalities of the described embodiments of the data transmission method can be advantageously implemented by means of software which typically locates in the Digital Signal Processor. The implementation solution can also be for instance an ASIC (Application Specific Integrated Circuit) component. A hybrid of these different implementations is also feasible. One possibility to implement the invention is to use a digital oscillator that is adapted to the compensation of Doppler shift.

Even though the invention has been described above with reference to an example according to the accompanying drawings, it is clear that the invention is not restricted thereto but can be modified in several ways within the scope of the appended claims

We claim

1. A method for compensating Doppler shift in a telecommunication system, where at least one user terminal is moving in relation to a network element, the method comprising:
measuring a received uplink signal;
estimating an amount of Doppler frequency compensation for at least one downlink signal related to a user terminal based upon a measured received uplink signal; and
compensating a Doppler shift for at least one downlink signal related to the user terminal by shifting a frequency of the signal according to the estimated amount of Doppler frequency compensation.

2. A method for compensating Doppler shift in a telecommunication system, where at least one user terminal is moving in relation to a network element and where there are at least two radio cells, one of them being a handover source cell and another a handover target cell, the method comprising:
measuring a received uplink signal in a source cell;
estimating in the source cell an amount of Doppler frequency compensation for at least one downlink signal related to a user terminal based upon a measured received uplink signal;
compensating a Doppler shift in the source cell for at least one downlink signal related to the user terminal by shifting a frequency of the signal according to the estimated amount of Doppler frequency compensation;
informing a handover target cell of a required Doppler shift compensation while performing a handover;
estimating an amount of Doppler frequency compensation for at least one user terminal related downlink signal of the handover target cell utilizing the information on the required Doppler shift compensation communicated from the source cell, and angles of velocity; and
compensating a Doppler shift in the handover target cell for at least one downlink signal related to the user terminal by shifting a frequency of the signal according to the amount of Doppler frequency compensation estimated in the handover target cell.

3. The method of claim 1, wherein the estimation takes into account the previously made Doppler effect compensation.

4. The method of claim 1, wherein the estimation of Doppler frequency compensation utilizes information on system geometry.

5. The method of claim 2, wherein the estimation of Doppler frequency compensation utilizes information on system geometry.

6. The method of claim 1, wherein the Doppler frequency compensation is performed for selected cells, if there are cells for user terminals located in a predetermined location.

7. The method of claim 2, wherein the received uplink signal measured in a handover source cell is informed to the handover target cell for initializing the Doppler frequency compensation estimation.

8. The method of claim 1, wherein the estimated amount of the Doppler frequency compensation is filtered or weighted for increasing estimation accuracy.

9. A data transmission system for compensating Doppler shift in a telecommunication system in which system at least one user terminal is moving in relation to a network element, the system comprising:
means for measuring a received uplink signal;
means for estimating an amount of Doppler frequency compensation for at least one downlink signal related to a user terminal based upon the measured received uplink signal; and
means for compensating a Doppler shift for at least one downlink signal related to the user terminal by shifting the frequency of the signal according to the estimated amount of Doppler frequency compensation.

10. A data transmission system for compensating Doppler shift in a telecommunication system in which system at least one user terminal is moving in relation to a network element, and in which system there are at least two radio cells, one of them being a handover source cell and another a handover target cell, the system comprising:
means for measuring a received uplink signal in a source cell;
means for estimating in the source cell an amount of Doppler frequency compensation for at least one downlink signal related to a user terminal on the basis of the measured received uplink signal;
means for compensating the Doppler shift in the source cell for at least one downlink signal related to the user terminal by shifting the frequency of the signal according to the estimated amount of Doppler frequency compensation;
means for informing a handover target cell of the required Doppler shift compensation while performing a handover;
means for estimating the amount of Doppler frequency compensation for at least one user terminal related downlink signal of the handover target cell utilizing the information on the required Doppler shift compensation communicated from the source cell and angles of velocity; and
means for compensating a Doppler shift in the handover target cell for at least one downlink signal related to the user terminal by shifting frequency of the signal according to the amount of Doppler frequency compensation estimated in the handover target cell.

11. The system of claim 9, further comprising means for taking into account in the estimation the previously made Doppler effect compensation.

12. The system of claim 9, further comprising means for utilizing, in the estimation of Doppler frequency compensation, information on system geometry.

13. The system of claim 10, further comprising means for utilizing, in the estimation of Doppler frequency compensation, information on system geometry.

14. The system of claim 9, further comprising means for performing the Doppler frequency compensation for the selected cells, if there are cells for user terminals located in a predetermined location.

15. The system of claim 10, further comprising means for informing the received uplink signal measured in a handover source cell to the handover target cell for initializing the Doppler frequency compensation estimation.

16. The system of claim 9, further comprising means for filtering or weighting the estimated amount of the Doppler frequency compensation for estimation accuracy.

17. A network element for compensating Doppler shift, said element comprising:
means for receiving measurement results regarding uplink signals;
means for estimating an amount of Doppler frequency compensation for at least one downlink signal based upon a measured uplink signal; and
means for compensating a Doppler shift for at least one downlink signal by shifting a frequency of the signal according to the estimated amount of Doppler frequency compensation.

18. A network element for compensating Doppler shift in a telecommunication system in which system there are at least two radio cells, one of.them being a handover source cell and another a handover target cell, the network element comprising:
means for receiving measurement results regarding uplink signals in a source cell;
means for estimating in the source cell the amount of Doppler frequency compensation for at least one downlink signal based upon a measured uplink signal;
means for compensating the Doppler shift in the source cell for at least one downlink signal by shifting the frequency of the signal according to the estimated amount of Doppler frequency compensation;
means for informing the handover target cell of a required Doppler shift compensation while performing a handover;
means for estimating the amount of Doppler frequency compensation for at least one downlink signal of the target cell utilizing the information on the required Doppler shift compensation communicated from the source cell and angles of velocity; and
means for compensating the Doppler shift in the target cell for at least one downlink signal by shifting a frequency of the signal according to the amount of Doppler frequency compensation estimated in the target cell.

19. The network element of claim 17, further comprising means for taking into account in the estimation a previously made Doppler effect compensation.

20. The network element of claim 17, further comprising means for utilizing in the estimation of Doppler frequency compensation information on system geometry.

21. The network element of claim 18, further comprising means for utilizing in the estimation of Doppler frequency compensation information on system geometry.

22. The network element of claim 17, further comprising means for performing the Doppler frequency compensation for the selected cells, if there are cells for user terminals located in a predetermined location.

23. The network element of claim 18, further comprising means for informing the received uplink signal measured in a handover source cell to the handover target cell for initializing the Doppler frequency compensation estimation.

24. The network element of claim 17, further comprising means for filtering or weighting the estimated amount of the Doppler frequency compensation for obtaining more accurate estimation.
